(19) United States
(12) Patent Application Publication
(10) Pub. No.: US 2010/0011921 A1
(43) Pub. Date: Jan. 21, 2010

(54) Apparatus and Method for Cutting Elongated Elements

(75) Inventor: Vagn-Erik Dall, London (GB)

Correspondence Address: Woods Oviatt Gilman LLP, 700 Crossroads Bldg, 2 State St., Rochester, NY, 14614, US

(73) Assignee: DALMATIC LYSTRUP A/S, Lystrup (DK)

(21) Appl. No.: 12/519,071

(22) PCT Filed: Dec. 12, 2007
(86) PCT No.: PCT/GB07/04761

§ 371 Date: Jun. 12, 2009

(30) Foreign Application Priority Data
Dec. 13, 2006 (GB) 0624870.2

(51) Int. Cl. B23D 23/04; B23D 29/02

(52) U.S. Cl. 83/13; 83/200; 83/673

(57) ABSTRACT

Apparatus for cutting an elongate element (2) comprises two lateral devices (6) for gripping the element on either side of a central section. A third device (10) fits between the lateral devices for gripping the central section, and together the gripping devices (6,10) define a common axis along which the element to be cut is aligned. With the devices installed on the element the lateral devices (6) are rotated relative to the third device (10) to twist and shear the central section from the element on either side.

This invention relates to a method and apparatus for cutting elongate elements where there is limited access to a respective element, and debris around the element at the point of cutting must be minimised. The invention has application in many engineering fields where complicated and delicate assemblies must be dismantled for example, and in surgery where similar situations must be addressed.

Many mechanical structures use elongate elements extending between component parts to fix the relative position or rotational orientation of those components. They can be used to prevent adjacent bolts from loosening by passing the element through diametral holes and/or fix the spacing between two components. After time, the coupling of the elements to the bolts or components can become locked, with the consequence that the element cannot be readily removed. The element may be incapable of removal for other means. It may be that the element interconnects more than two bolts or components for example, and only the coupling with two of them needs to be dismantled.

In circumstances such as those described above, an element extending between two components can be broken using single or double bladed cutters, or by sawing. However, both these techniques can be difficult in regions where access is restricted, and where it is important that there is minimal movement of the element being cut and the severed ends.

The present invention is a shear technique for cutting an elongate element. Reference is directed in this respect to International Patent Publication No: WO00/07512 (incorporated herein by reference) in which telescopically engaging gripping devices twist an elongate element in opposite directions to break the element at a shear plane defined axially between the devices. According to the present invention, an elongate element is cut by the removal of a section therefrom using shear cutting techniques. In the method of the invention, the element is gripped at either end of the section and the section itself is gripped separately. The section is then rotated relative to and about the axis of the elongate element at either end thereof to shear the element at shear planes defined at the respective ends of the section.

Apparatus according to the invention comprises two lateral devices for gripping the element at either end of the section to be removed, and a central device for gripping the section itself. When installed on the element, the gripping devices are adapted to define a common axis substantially aligned with the axis of the element, and means are provided for rotating the central element relative to the lateral devices about that common axis. The two lateral devices are typically mounted on a common structure, and with the central device form an integrated assembly when installed on the element to be cut. Various means can be provided for accomplishing the requisite relative rotation of the central device relative to the lateral devices. Typically, such means will include lever arms extending from the respective devices. It will be appreciated that, particularly where space is very restricted, multiple and/or reciprocal relative rotation of the section to be removed relative to the other element sections may be required. It will also be appreciated that considerable force may be required, and a geared mechanism coupled to the gripping devices or to arms extending therefrom to effect the requisite movement or movements can be provided for the purpose.

In preferred embodiments of the invention, when installed on the element to be cut, the central gripping device forms annular faces in juxtaposition to complementary faces formed on the lateral devices, all of which faces are substantially perpendicular to the common axis of the elongate element. The shear planes at which the section is separated from the remainder of the element are defined by the respective juxtaposed faces. In a particularly preferred embodiment, each lateral devices forms a boss which, when installed on the element to be cut, is received in one of two oppositely facing recesses in the central device, the base of which defines parallel faces in juxtaposition with the faces of the bosses. The respective boss and recess-engagements define simple plane bearings for the relatively rotating devices.

Apparatus according to the invention will not normally be used in situations where an exposed length of an elongate element must be removed. In those circumstances a device of the kind described in International Patent Specification No: WO00/07512 can be used. Normally then, the gripping devices in apparatus according to the present invention must be designed to engage laterally rather than axially, with the element to be cut. To facilitate such engagement, each device will normally comprises at least two jaws for gripping the element and these jaws may have teeth for engaging the exposed surface of the element to be cut. As is described below, the element may have axially extending grooves on its surface for receiving such teeth. Any combination of jaws on a gripping device will normally comprise at least two pivotally interconnected jaws, with a latch or other suitable locking mechanism. It will be appreciated in this context that the particular apparatus according to the invention will be designed for cutting elements of a particular diameter. Different jaws can be designed to accommodate different diameters. In many specialist applications it is more appropriate to match the apparatus with the particular element diameter.

The invention will now be described by way of example and with reference to the accompanying schematic drawings wherein:

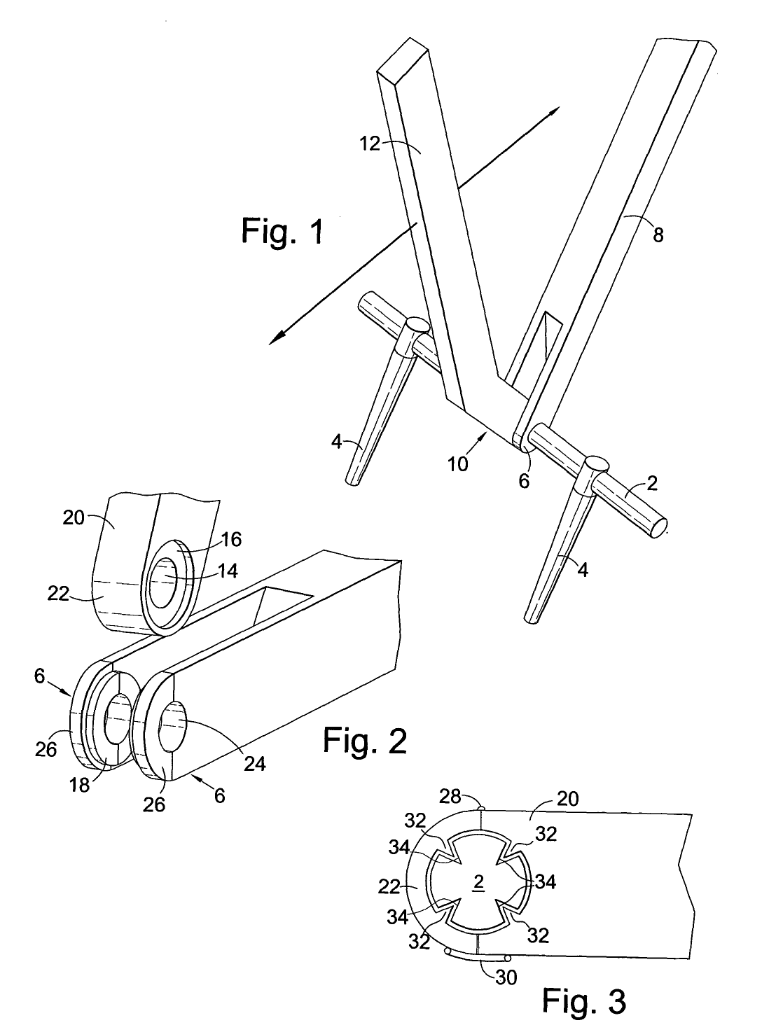

FIG. 1 shows a perspective view of apparatus according to the invention installed on an element to be cut;

FIG. 2 is a detailed view showing how the central and the lateral gripping devices complement each other; and

FIG. 3 illustrates a gripping device engaging an element to be cut.

As shown in FIG. 1, an elongate element 2 extends between two components 4 which are themselves part of a substrate device or mechanism, not shown. Two lateral gripping devices 6 extend from a common arm 8 to surround and engage the element 2. A central gripping device 10 fits between the lateral devices 6, and is connected to an arm 12. With the gripping devices installed, the central device 10 is locked around a section of the element 2 (not visible) between the two lateral devices and when the arm 12 is rotated about the axis of the element, and of the aligned lateral gripping devices, it proceeds to disrupt the structure of the material of the element 2 between the central and the respective lateral gripping devices, and extended or repeated relative rotational movement of the gripping devices will eventually shear the element at two planes at either end of the section gripped by the central device, and the central gripping device can then be removed with that element section.

FIG. 2 shows in a little more detail, the manner in which the central and lateral gripping devices cooperate. As can be seen, with the gripping devices closed the central device 10 defines a hole 14 with an annular recess 16 at either end (only one is shown). Each of the lateral devices 6 is formed with a boss 18 which, when all three devices are installed on the element, fits neatly into the corresponding recess 16 in the central device. The central device has a fixed jaw 20 and a movable jaw 22 so that when the movable jaw 22 is fully opened, the central device can be fitted between the lateral devices with the bosses 18 received in one half of the respective recess 16 in the central device, before closure to complete the two recesses around the two bosses 18 on the lateral devices.

Each of the lateral gripping devices shown is also formed with a fixed jaw 24 and a movable jaw 26 so that the lateral devices can be installed on the element to be cut before the central device 10 is fitted. Once all three devices are fitted and the respective jaws locked around the element 2, the relative rotation of the gripping devices can be initiated, and eventually the element will break at the shear planes defined by the bosses and recesses. The movable jaw 22 on the lateral devices is then released and all three devices can then be withdrawn with the removed element section still held by the central gripping device.

FIG. 3 illustrates a preferred mechanism by which the central and lateral gripping devices can effectively engage an elongate element to be cut. The same mechanism can be used on the central and the lateral devices but for ease of understanding, parts will be identified with reference to the central gripping device 10. The device has a fixed jaw 20 and a movable jaw 22. The movable jaw is pivotally attached to the fixed jaw by a hinge 28. The fixed and movable jaws define an opening of circular cross-section for receiving the element 2. The movable jaw extends around one half of that circular cross-section and its distal end engages the opposite side of the fixed jaw 20 by means of a latching mechanism 30. Although the twisting forces that must be applied are considerable, in order to simultaneously break the element at two relatively close shear planes, these forces do not apply directly to either the hinge 28 or the latch 30. The abutting surfaces of the diametrically opposed ends of the respective jaws should ensure that the forces on the hinge 28 and latch 30 are minimised.

As can be seen in FIG. 3, each of the fixed and movable jaws 20 and 22 is formed with a pair of teeth 32 which extend the axial length of the hole defined by the jaws in their closed position. The element is formed with complementary axially extending grooves 34, and the four teeth are received in the respective four grooves of the element.

According to the invention elongate elements or rods are broken along cross-sectional shear planes. When adjacent sections are twisted relative to each other and sufficiently beyond the elastic limit for a stainless steel rod, the elastic limit is reached after relative twisting about a shear plane of around 45°. In order to break a stainless steel rod using the apparatus and method of the invention, we have found that three reciprocal rotations of around 60° is required. For an elongate element or rod of titanium, which has high elasticity, a single relative rotation of around 60° to 65° can be sufficient. Where multiple movements are required in the same rotational sense, then a ratchet mechanism can be employed to accomplish this. Such a mechanism may be required in any event where space is particularly restricted.

As noted above, the technique of the invention has application in many engineering and surgical fields. In surgical operations where bone sections or individual bones (such as vertebra in the spine) must be fixed relative to each other, this is typically accomplished using an elongate element extending between components secured in the respective bone or bone part. When the fixation mechanisms must be removed or replaced, it is generally easier and safer to cut the connecting element or rod to remove the fixation components, than to dismantle the mechanism with the element or rod intact. The restricted access to the fixation mechanism will be readily appreciated, as will the need to avoid dissipation of debris that would be generated if the element or rod were cut. Similar situations are created in other engineering fields, particularly where corrosion between components and rods effectively locks them together.

1. Apparatus for cutting an elongate element by removal of a section therefrom, which apparatus comprises two lateral devices for gripping the element at either end of said section; a central device for gripping said section, the gripping devices being adapted to define a common axis substantially aligned with the axis of the element when installed thereon; and means for rotating the central device relative to the lateral devices about said common axis when installed on a said element to shear a said section therefrom at either end thereof.

2. Apparatus according to claim 1 wherein each gripping device comprises at least two jaws for gripping a said element.

3. Apparatus according to claim 2 wherein the jaws have teeth for engaging axially extending grooves on a said element.

4. Apparatus according to claim 1 wherein at least one gripping device comprises two pivotally interconnected jaws.

5. Apparatus according to claim 1 wherein the lateral gripping devices are mounted on a common structure.

6. Apparatus according to claim 1 wherein the central device forms annular faces adapted to be in juxtaposition to complementary faces formed on the lateral devices, all of which faces are substantially perpendicular to said common axis, when installed on a said element.

7. Apparatus according to claim 6 wherein each lateral device forms a boss with a said complementary face thereon, each boss being received in one of two recesses in the central device, the base of which defines said parallel faces, when installed on a said element.

8. Apparatus according to claim 1 wherein the rotating means comprises arms extending from the respective devices.

9. Apparatus according to claim 1 including a mechanism for operating the rotating means.

10. Apparatus according to claim 9 wherein the mechanism is selectively attachable to the devices.

11. A method of cutting an elongate element by removal of a section therefrom; comprising gripping the element at either end of the section; separately gripping the section itself; and rotating the section relative to and about the axis of the element at either end thereof to shear the element at both ends of the section.

12. A method according to claim 11, using apparatus comprising one central and two lateral gripping devices on said axis of said elongate element respectively gripping the section and the element at either end of the section, with arms extending from the devices in a direction perpendicular to said axis, said section being rotated relative to the element at either end of the section by reciprocal rotation of the arms about said axis.

13. Apparatus for cutting an elongate element comprising two lateral devices for gripping either end of a length of said element; a central device for gripping a section of said element within said length, the gripping devices defining a common axis to be aligned with the axis of the element when installed thereon; and wherein annular faces on the central device are in juxtaposition to complementary faces on the lateral devices, all of which faces are substantially perpendicular to said common axis, and means for rotating the central device relative to the lateral devices about said common axis when installed on a said element to shear a said section therefrom at either end thereof.

14. Apparatus according to claim 13 wherein the complementary face on each lateral device forms a boss received in one of two recesses in the central device, the bases of which bosses have parallel faces perpendicular to the common axis.
